(19) United States
(12) Patent Application Publication
(10) Pub. No.: US 2006/0218488 A1
(43) Pub. Date: Sep. 28, 2006

(54) Plug-in architecture for post-authoring activities

(75) Inventors: Mehul Y. Shah, Redmond, WA (US); Dongmei Zhang, Bellevue, WA (US); Vladimir Rovinsky, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/091,864

(22) Filed: Mar. 28, 2005

(51) Int. Cl. G06F 17/00

(52) U.S. Cl. 715/516

(57) ABSTRACT

The subject invention provides a system and/or a method that facilitates saving authored content and/or file in a format respective to an output for presentation or an activity to perform with the content. A content author component can create the content and/or file. A post-author component can save the content and/or file to a format respective to the output or activity to perform with the content to mitigate complications involved with displaying the content and/or performing the activity. The format associated to the respective output or activity can include at least one setting. Additionally, a plug-in component can provide the format respective to the output or activity and implement the post-authoring activity, wherein the plug-in component can be a third party plug-in component.

### CROSS-REFERENCE TO RELATED APPLICATION(S)

This application is related to U.S. Pat. No. 6,803,925 filed on Sep. 6, 2001 and entitled “ASSEMBLING VERBAL NARRATION FOR DIGITAL DISPLAY IMAGES,” and co-pending U.S. patent application Ser. No. 10/924,382 filed on Aug. 23, 2004 and entitled “PHOTOSTORY FOR SMART PHONES AND BLOGGING (CREATING AND SHARING PHOTO SLIDE SHOWS USING CELLULAR PHONES).” This application is also related to co-pending U.S. patent application Ser. No. 10/959,385 filed on Oct. 6, 2004 and entitled “CREATION OF IMAGE BASED VIDEO USING STEP-IMAGES,” co-pending U.S. patent application Ser. Nos. 11,074,414, ______ (Docket No. MS310525.01), Ser. No. ______ (Docket No. MS310560.01), and Ser. No. ______ (Docket No. MS310939.01), titled “PHOTOSTORY 3—AUTOMATED MOTION GENERATION,” Ser. Nos. “______,” “______,” and “______,” filed on Mar. 8, 2005, ______, ______, and ______, respectively.

### TECHNICAL FIELD

The present invention generally relates to computer systems, and more particularly to systems and/or methods that facilitate authoring applications to save their results into a suitable format for a particular output.

### BACKGROUND OF THE INVENTION

There are several computer applications that allow authoring of content and saving results in a specific format. For example, a word processing application is a document authoring application that allows a user to author a document and save the result in specific document file format such as, for example, a “.doc” file or an “.html” file. Similarly, a movie maker application is a video authoring application that allows users to author and edit videos and save the results into a specific video format. In still another example, a digital image editing application can provide photo editing that allows users to author and edit photos and save the results into specific image file formats.

In one particular example, an image-based video can be authored by users by using their digital pictures, adding voice narration, adding background music, adding panning and zooming motion to their pictures and creating a slide-show like video. After authoring an image-based video, the user can perform different activities—such as saving the image-based video as a file on a computer for future playback, transferring the video to a device such as a PDA or cell-phone for viewing on the device, transferring the video to a DVD or a VCD disk for playback on TV, sending the video as an email attachment, uploading the video to a sharing website to share, etc. Each of these activities requires the resulting video to be saved in a specific format using specific attributes of video resolution, frame rate, file size, etc. that make the content suitable for that activity.

Users of such authoring software typically save results into an intermediate format—to allow them to continue editing—and into a result format—based at least in part upon further actions involving the authored content. For instance, the user of a document authoring software can save the resulting document in an “.html” format to publish the document in the form of a web-page viewable over the Internet. Similarly, the user of a photo authoring application can save the result as a JPEG file to share with friends and family. In yet another example, the user of a video editing application can save the results into a MPEG file to generate a DVD or VCD disc containing the video.

With the availability of several different file formats for documents, photos, videos, spreadsheets and other types of authored content, there is a need for authoring applications to guide users in selecting the appropriate file format respective to the activity they want to perform with the resulting content. Taking this concept further, there is a need for applications to hide the complexity of various content file formats completely from users and simply guide them in saving the results based on the post-authoring activity and to perform such post-authoring activity.

Also, with the availability of several different types of file formats for content, it becomes difficult for authoring applications to support the ability to save resulting content into all possible formats. For example, a new format associated to a new type of activity can be available after the authoring application has been released. In particular, computer hardware and software that allows users to save their digital videos in the form of DVD's has recently become prevalent. It would be difficult for consumer video authoring applications created a few years ago to have predicted this trend and to have supported the ability to create DVD's from their video editing applications. There is a need for authoring applications to support a plug-in architecture and framework that allows components to be developed after the authoring application has been released that provide the ability to save the resulting content into different possible formats.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention relates to systems and/or methods that facilitate authoring of content and saving the results to a format related to an output for presentation. In the example of the authoring application being an application that allows users to create image-based video, a content author component can create the result using settings that are optimal for a specific activity. These settings can be one or more of the video dimension, the video frame rate, the video bit-rate, the video file size, and any other setting that influence the quality of displaying the content using a specific output device. A post-author component can create the video and/or file to the format optimized for the output device or activity wherein such format is specified by plug-ins. Also, the post-author component can use plug-ins to perform additional activities after the file is saved—such as, but is not limited to, transferring the video and/or file to the specific output device.

The post-author component can guide a user through creation of the content and/or file to facilitate displaying the content to an output device or performing specific activities with the content. For example, if the content is video, the user can perform the following operations utilizing the post-author component: transferring to a cellular phone, uploading to a website, emailing, displaying on a television (e.g., a high definition television), conveying to a portable device, writing to a compact disc, and providing to a CD/DVD writing application, etc. wherein such activities are implemented by plug-in modules. Each operation can include optimal settings to which the display and/or activity is most efficient and/or beneficial. For instance, in case of video content, the optimal settings can be related to at least one of audio quality, video quality, video frame rate, video resolution, variable bit-rate, and constant bit-rate, wherein such settings can be determined based upon the output.

In accordance with one aspect of the subject invention, a plug-in component can provide the format related to the output for presentation and/or desired activity. The plug-in component can provide numerous formats particular to an output related to such plug-in component and also specify one of these formats as a preferred (default) format. In other words, formats and outputs not initially associated with the post-author component and/or the content author component can be implemented by utilizing the plug-in component. Moreover, it is to be appreciated that the plug-in component can be a third party plug-in component. Thus, an extensible and versatile architecture is provided to create the content and/or file to a format optimized to the output and/or activity.

In accordance with another aspect of the subject invention, an interface can provide communication between the post-author component and at least one plug-in component. The interface can provide universal methods and/or functions which the third party plug-in component can utilize to specify the format and respective output, wherein the format is associated to such third party plug-in component. Furthermore, the interface can allow the third party plug-in component to employ a third party plug-in component interface to provide a conversion or transfer or any other post-authoring activity associated to a third party.

In accordance with yet another aspect of the subject invention, a profile can be utilized to provide the format and optimal settings. The profile can be an extensible markup language (XML), using a schema to define attributes of the format such that the schema is understandable and recognized by both the authoring application as well as the plug-in. In one example, the profile can be in the form of an XML file and can be provided by the plug-in to specify a format that can be utilized and interpreted by the authoring application as the format to save the resulting content. In another example, a pre-defined set of profiles in the form of XML files can be provided by the authoring application as possible formats in which the content can be saved—the plug-in can specify one such format that is optimal for the activity supported by the plug-in. In the example of the image-based video authoring application (e.g., where the resulting content type is video) at least one of the following can be provided by the XML file: video and audio format attributes such as, but are not limited to, aspect ratio, video and audio bit rate, video resolution and other video encoding attributes; a name to display; a description to display; and a global unique identifier. In other aspects of the subject invention, methods are provided that facilitate creation of the content and/or file to a format optimized to an output for presentation or a desired activity.

The following description and the annexed drawings set forth in detail certain illustrative aspects of the invention. These aspects are indicative, however, of but a few of the various ways in which the principles of the invention may be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a block diagram of an exemplary system that facilitates creation of content and/or file in a particular format.

FIG. 2 illustrates a block diagram of a system that facilitates creation of a video and/or file in a format optimized for an output and/or device and/or activity.

FIG. 3 illustrates block diagram of a system including a post-author component that facilitates creation of a content and/or file to a format optimized for a particular output and/or device and/or activity—the content type assumed in this example being video.

FIG. 4 illustrates a block diagram of an exemplary system that facilitates creating a video and/or file in a particular format utilizing at least one plug-in.

FIG. 5 illustrates a block diagram of an exemplary system that facilitates creating a video and/or file utilizing intelligence.

FIG. 6 illustrates a user interface that facilitates creation of a video and/or file in a particular format.

FIG. 7 illustrates a user interface to customize a format for a video and/or file creation.

FIG. 8 illustrates a user interface to perform any post-authoring activity after the video and/or file is saved.

FIG. 9 illustrates an exemplary methodology for creating a video and/or file in a particular format.

FIG. 10 illustrates an exemplary methodology for creating a video and/or file in a particular format.

FIG. 11 illustrates an exemplary networking environment, wherein the novel aspects of the subject invention can be employed.

FIG. 12 illustrates an exemplary operating environment that can be employed in accordance with the subject invention.

### DESCRIPTION OF THE INVENTION

As utilized in this application, terms “component,” “system,” “wizard,” “store,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The subject invention is described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

In most of the figures and descriptions below, an exemplary content type of video is considered. It is to be appreciated and understood that the techniques described here can be applied in the case of authoring other types of content such as, but not limited to document files, spreadsheets, images, presentations, and/or any suitable application that has a file/content that can be optimized for a particular output and/or display. Additionally, the following description involving systems, components, and the like are not so limited to the content type of video, rather, the subject invention can be applied to various applications having a respective file/content that can be optimized for a particular output and/or display.

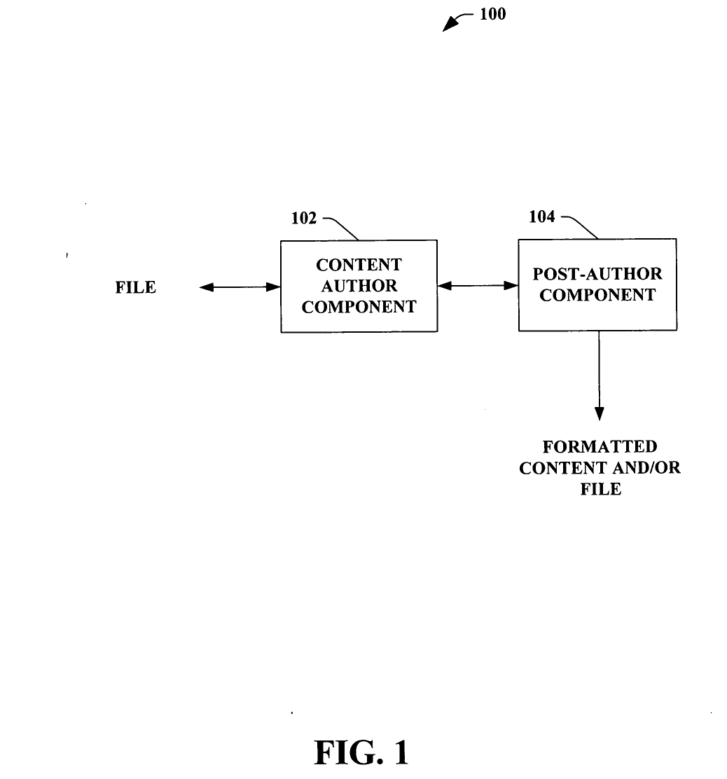

Now turning to the figures, FIG. 1 illustrates a system 100 that facilitates creating a content and/or file in a particular format. The content and/or file can be viewed on a growing number of electronic devices, mediums, displays, etc., which each can include a particular format associated therewith. For instance, in case of video content, the video and/or file can be displayed on a computer, transferred to a portable device (e.g., Pocket PC, cellular phone, portable player . . . ), displayed on a laptop, played on a television, transferred to a digital medium, uploaded to a website, sent in an email, etc. It is to be appreciated that various post-authoring (e.g., after the creation of a content and/or file) activities can be employed to the content and/or file and any suitable activity can be utilized in conjunction with the subject invention. Furthermore, each post-authoring activity can have a format associated thereto, wherein the format can have a multitude of settings related to a particular output. For instance, in case of video content, the post-authoring operation can be a transfer to a cellular phone that has a related format including optimized settings to provide high quality display of the video and/or file such that the settings optimally utilize the specific display and CPU characteristics of the cellular phone.

A content author component 102 can receive one or more inputs for the content. In the example of the image-based video authoring application, the input consists of one or more images and/or files to be incorporated to provide an aesthetically pleasing viewing experience with the video and/or file. It is to be appreciated that the video can include a plurality of images with audio and/or motion incorporated therewith. For instance, a user can capture images with a digital device, upload the images to a computer, and add music and/or motion to the image. The content and/or file can be created utilizing, for instance, software, an application, a website, a user interface, a graphic user interface, a remote system, a computer, etc.

A post-author component 104 can format the video and/or file with optimal settings according to an output target, wherein the output target can be, but is not limited to, a television, a cellular phone, a projector, an email application, a website, a compact disc, a CD writing application, a digital video disc, a PDA, a pocket PC, . . . . It is to be appreciated and understood that each output target can have a unique format, wherein the format can include optimal settings related to the respective format. For example, if the output target is a cellular phone and the content is video, the content and/or file needs to be saved in a format that has settings optimized to provide high-quality viewing, wherein the settings can be related to at least one of audio, resolution, video, screen-size, etc. The determination of such settings can be automatic based at least upon pre-defined knowledge of characteristics such as the display size, CPU, etc. for the particular output target. The post-author component 104 can provide a framework to create the video and/or file in a particular format for a particular device and/or output target. Furthermore, the post-author component 104 can provide a manual configuration of the optimal settings. A technologically advanced user can manually choose and/or configure the optimal settings relating to a format for an output target. Although the post-author component 104 can provide the format and related optimal settings, it is to be appreciated that a separate component and/or entity can provide the format to the post-author component 104 for any suitable format based on where the content and/or file will be employed. For example, a vendor can provide a format for the video and/or file with optimal settings allowing such video and/or file to be invoked on a vendor specific device (e.g., via a plug-in component). It is to be appreciated that the post-author component 104 can also be a post-author wizard, wherein “wizard” and “component” can be interchangeable.

Furthermore, it is to be appreciated that the post-author component 104 can receive any suitable file, document, video, image, to allow such post-authoring operations. In other words, the post-author component 104 is not limited to video implementations. For example, a user can create a word processing document, wherein the post-author component 104 can implement the post-author operation on the word processing document based at least in part upon the output device for the document or activity to be performed on the document. Thus, the post-author component 104 can use optimal settings and/or configurations to allow the document to be suitably presented with a particular format or to be used for the activity.

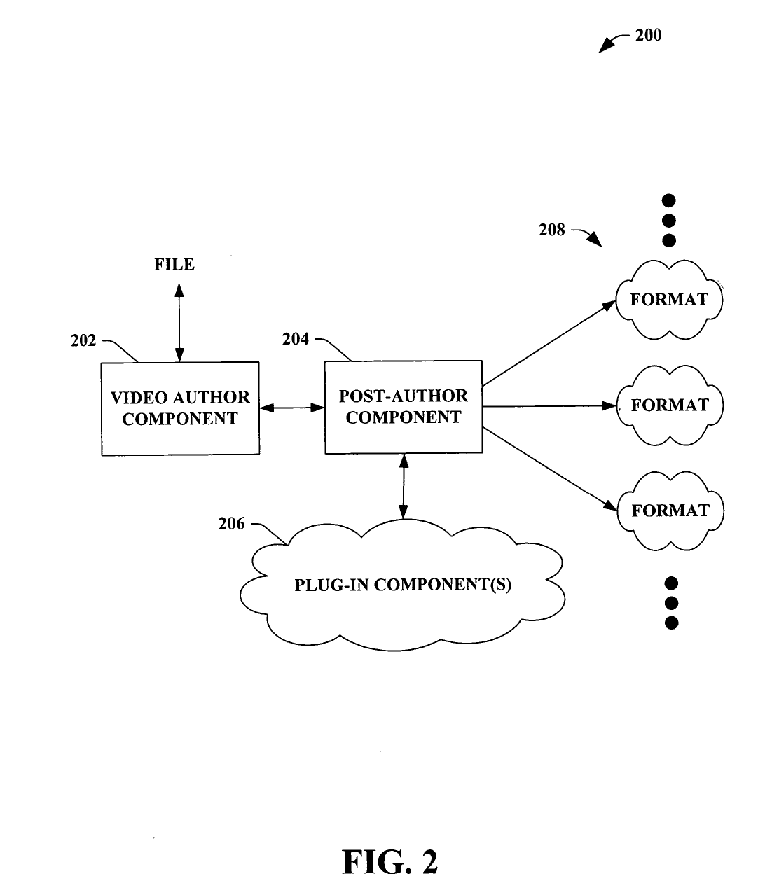

FIG. 2 illustrates a system 200 that facilitates creating a video and/or file in a format for an output and/or device and/or activity. A video author component 202 can create the video. Moreover, the video author component 202 can receive and/or create a file associated to an authoring operation (e.g., creating a file, editing a file, . . . ). Although the example depicts a video author component 202 for authoring video content, the concept can be applied to an author component for creation of any type of content such as, but not limited to, a word processing document, an image, a spreadsheet, a presentation or any other content type. A post-author component 204 can save the video, file, and/or document in the format related to the output and/or device on which the video, file, and/or document is to be displayed such that it is displayed optimally. For the sake of brevity, the following description relates to video, yet the subject invention is not so limited. A post-authoring activity can be employed by a user such as transferring to a cellular phone, uploading to a website, transferring via email, displaying on a television, displaying on a high definition television, transferring to a portable device, transferring to a compact disc, transferring to a CD writing application, etc., wherein the output is the respective medium and/or device. It is to be appreciated and understood that a user can determine the output to transfer and/or display the video and/or file.

Furthermore, the post-author component 204 can guide a user to save the video and/or file in a format related to the output and/or device by utilizing a plug-in component(s) 206. The plug-in component(s) 206 can be an API, a vendor product, application, software, an interface, a GUI, etc. that can additionally invoke a particular post-authoring activity to be performed (e.g., such as transfer to device, transfer to CD, upload to website, etc.) on the content saved in the specific format. It is to be appreciated and understood that a plurality of plug-in component(s) 206 can be employed in conjunction with the post-author component 204 to provide a plurality of formats 208. For example, a plug-in component can provide the post author component 204 with format and settings of video optimized for storing to CD. The post-author component 204 can utilize the plug-in component to obtain the optimal settings to store video on a CD. Additionally, the post-author component 204 can allow a manual configuration of the optimal settings for saving video on CD.

After the content is saved in a format optimized for an output and/or device and/or activity, the post-author component 204 can allow the plug-in component(s) 206 to implement user interface to guide the user to perform any further tasks that may be needed after saving such content. For instance, the post-authoring activity can be a creation of a DVD with a DVD plug-in component, wherein the post-author component 204 can invoke the user interface provided by the DVD plug-in component to guide the copying of the video to DVD (e.g., selecting a DVD drive, a speed, a progress of writing, displaying copy progress, . . . ).

It is to be appreciated that the plug-in component(s) 206 provides an activity that can be performed by the user after the content is authored. A list of possible activities to perform with the video and/or file can be determined by the post-author component 204 by parsing through the list of available plug-ins, each of which supports one or more activities to be performed with the authored content. For instance, the following tasks can be performed by the plug-in component(s) 206: provide a user friendly description text of an activity which a user can perform with a content after it is authored; specify a global unique identifier (GUID) (or any other form of unique identification) of a preferred profile that contains optimal settings for saving the content if a user chooses such option (e.g., the profile can be one of many profiles installed by the post-author component 204 or a custom profile created and installed by the plug-in); specify a list of profiles that can be utilized with the respective plug-in component(s) 206 to perform the activity; determine whether to allow users to explicitly save the video and/or file on their computer as part of the activity; and determine if any additional steps (e.g., writing the CD, uploading the files to a website, emailing the files, . . . ) are needed after the video and/or file has been saved.

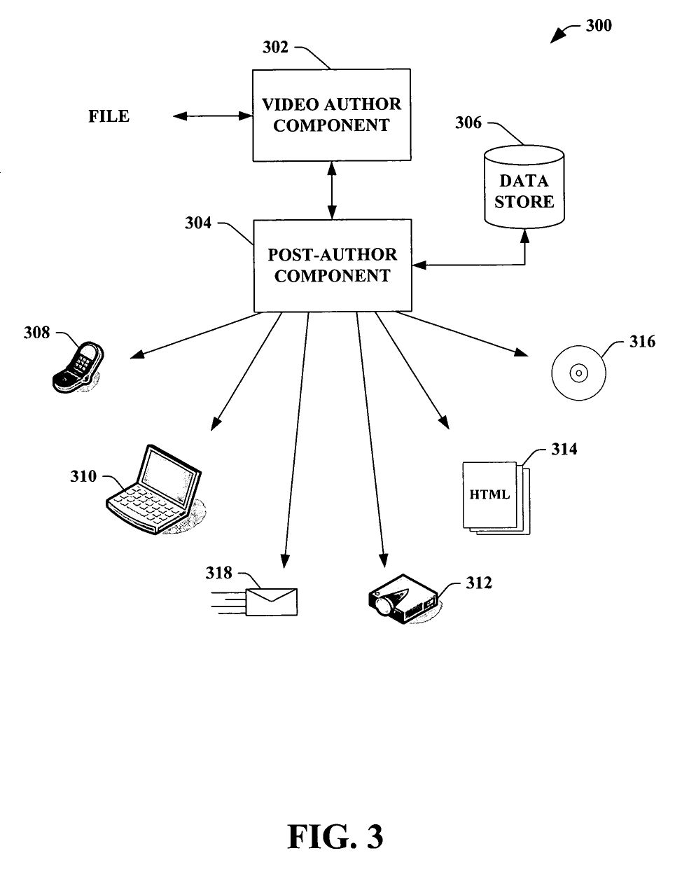

FIG. 3 illustrates a system 300 that facilitates saving a content and/or file to a format for a particular output and/or device and/or activity. Using the exemplary content type of video, a video author component 302 can be employed to create the content video and/or file. It is to be appreciated that the video author component 302 is not so limited to authoring video, but rather any content author component can be employed and/or utilized by the subject invention. A list of possible activities to perform with the video and/or file can be determined by a post-author component 304 by parsing through the list of available plug-ins, each of which supports one or more activities to be performed with the authored content. Each activity corresponds to an output and/or a device such that the content needs to be saved for optimal display on such output and/or device. An activity and/or an output to display the video and/or file can be chosen by a user. Based at least in part upon the user preference for output, the post-author component 304 can save the authored video and/or file in a particular format associated to the chosen output for presentation or chosen activity to be performed on the video.

The post-author component 304 can employ a profile that relates to a format for a post-authoring operation. The profiles can be provided by a plug-in component (not shown), a user (custom-made), a video author component 302, a third-party plug-in component, etc. In one example, the plug-in which provides functionality for supporting an activity or supporting an output and/or device would specify the profile that contains settings optimized for displaying the content on that output and/or device or optimized for the activity.

It is to be appreciated that the profiles are specific to the type of content to be saved and they specify the format that the content is saved into. In case of video content, the profile can be an XML file that defines, amongst other things, encoding parameters (e.g., amount of compression, constant or variable bit rate encoding), audio quality, video quality, video frame rate, video resolution, etc. The profile can include (1) a name and a description for display by an application; and (2) a unique global identifier (GUID and/or any other form of identification that is unique across profiles) for identification. Although the above provides sample characteristics of a profile, it is to be appreciated that such details are merely exemplary and the subject invention is not so limited.

Furthermore, a data store 306 can be invoked to store profiles utilized in accordance with the subject invention. Thus, profiles from a plug-in component, a user, a video author component 302, a third-party plug-in component can be stored in the data store 306. It is to be appreciated that the data store 306 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 306 of the subject systems and methods is intended to comprise, without being limited to, these and any other suitable types of memory. In addition, it is to be appreciated that the data store 306 can be a server and/or database.

The post-author component 304 can guide a user to save the video and/or file in a format optimized for a specific output and/or device and/or activity. If the content type is video and the user desires to save the video and/or file to a format suitable for display on a cellular phone 308, the post-author component 304 can invoke the corresponding plug-in that implements such activity and guide the user to save the authored content utilizing the profile containing settings optimized for display of the content on the cellular phone. The profile can provide the optimal settings to display the video and/or file on the cellular phone 308, which can include audio quality, video quality, video frame rate, and video resolution. The user can also utilize the post-author component 304 to save the video and/or file in optimal format for playback on a laptop 310. Similarly, the post-author component 304 can utilize a profile with settings optimized for sending video in an email output 318.

Furthermore, a profile can be related to formatting the video and/or file for a digital projector 312. The post-author component 304 can save the video and/or file with optimal settings relating to the respective digital projector 312 for presentation. In another example, the post-author component 304 can use a plug-in to guide the user to format the video and/or file for uploading to a website 314 by utilizing a profile with optimized settings to upload the video and/or file to the website 314 to provide high quality presentation and ease of transferability (e.g., a compressed file). Additionally, the post-author component 304 can provide optimal settings via a profile associated with transferring the video to a compact disc (CD) 316. It is to be appreciated that although the post-author component 304 utilizes a profile that provides optimal settings for a specific output and/or device and/or activity, the user can interrupt the automated process to incorporate adjustments to the optimal settings and/or select a different profile. Moreover, the profiles can be provided by the post-author wizard 304, a plug-in component (not shown), the video author component 302, a data store 306, a user, a download, a website, . . . .

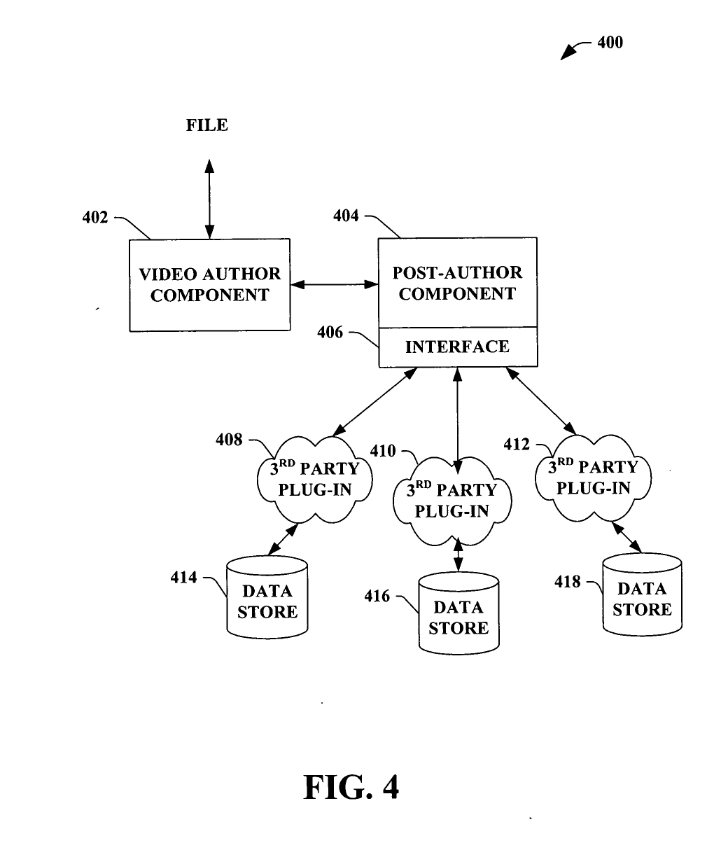

FIG. 4 illustrates a system 400 that facilitates providing optimal settings for a video and/or file in a format respective to an output. Again, the example where the content type being authored is video is considered—but the concepts can be applied to other authoring applications (e.g., applications relating to document files, spreadsheets, images, presentations, and/or any suitable application that has a file/content that can be optimized for a particular output and/or display) without diverging from the scope of the invention. A video author component 402 can create a video and/or file. A user can determine a post-authoring operation and the video and/or file is formatted according to the output and/or device. The saving of the video and/or file can be invoked by a post-author component 404 that provides guidance to the user. The post-author component 404 can utilize a profile that has optimal settings relating to the respective output. Although the subject invention utilizes the profile to encapsulate optimal settings relating to the output, it is to be appreciated and understood that any suitable format and/or file system can be employed.

The post-author component 404 can further utilize a plug-in component (not shown) to provide the post-authoring operation with the output and a respective format. For example, a company can provide a video author component and a post-author component that can save a video and/or file in a particular format. However, the company can later offer a plug-in component to save the video and/or file to a new format related to a new output and/or device and/or activity. It is to be appreciated that this plug-in can specify profiles previously released, newly created profiles, and/or implement custom profiles, to provide formats associated to the outputs.

Furthermore, the post-author component 404 can utilize an interface 406 to facilitate utilizing at least one third-party plug-in component(s). The third party plug-in components 408, 410, and 412 (collectively referred to as the third party plug-in components) can specify formatting for the video and/or file allowing numerous outputs for presentation. The employment of the interface 406 can provide an extensive and flexible architecture, wherein third-party components can seamlessly integrate into the post-author component 404 to allow creation and/or manipulation of the video and/or file. Additionally, it is to be appreciated that each third party plug-in component 408, 410, and 412 can utilize a data store (414, 416, and 418 respectively) that can store at least one profile associated to the output provided.

The third party plug-in component can provide a setup program for installing and uninstalling to facilitate integration capabilities. Before the third-party plug-in component can implement the interface to be utilized with the system 400, registration and/or verification can be invoked by one of the post-author component 404, the interface 406, the video author component 402 or another application module (not shown) suitable to provide a content and/or file that can be optimized for an output and/or display. It is to be appreciated that registered and/or verified plug-in components can be defined by the post-author component 404 (e.g., the component that creates the video and/or file in a format that is optimized for the output/device/activity).

The interface 406 allows communication between the post-author component 404 and at least one of the third party plug-in components 408, 410, and 410. Various methods and/or functionality can be implemented with the interface 406 and it is to be appreciated that any suitable interface and corresponding functionality can be utilized with the subject invention. The interface 406 can be programmed in interface description language and/or any suitable computer programming language.

The interface 406 can determine whether to save a file (e.g., the video and/or file). If the third party plug-in component requires the file to be saved, the user can specify a location for saving. If the third party plug-in component does not require a save, the video and/or file can be saved in a temporary location. In either case, the video and/or file can be transmitted to the third party plug-in component for post-authoring operations as long as it supports such operation.

The interface 406 can determine a GUID (or any other form of unique identification) of a profile, wherein the GUID can be of a profile that is associated to the video author component 402 or a GUID of a custom profile respective to the third party plug-in component. The profile corresponding to the GUID can exist in one of an install location for the profile. It is to be appreciated that the profile corresponding to the GUID can be utilized as a default profile for an output (e.g., a post-authoring activity) selected by a user.

The interface 406 can implement a methodology and/or functionality to provide a number of supported profiles. The third party plug-in component can support at least one profile. Additionally, custom profiles can be supported for a publishing option in the third party plug-in component. In such scenario, the user can be limited to choose a profile form the list of supported profiles as indicated by the third party plug-in component.

The interface 406 allows each of the plug-ins 408, 410, 412 to provide a title for the post-authoring operation (output and/or device and/or activity) that the plug-in supports. The titles can be displayed as options to the user in the post-author component screen. The screen can be where the user chooses what to do with the video and/or file. For instance, a third party plug-in component 408 can provide the post-authoring operation of uploading to a website. The plug-in interface 406 can provide the title to display to the user such as, “Upload your video and/or file to a web site group page”

Moreover, the interface 406 can implement functionality to allow the plug-in component to indicate whether it supports any operation that needs to be performed after the content file is saved. If yes, methods and/or functionalities related to operations performed after saving the content may be called. For example, if a plug-in supports providing a profile with settings optimal for playback on a PC, the corresponding activity is to save the file on the computer and there is no operation to be performed after the content is saved. Yet, if a plug-in supports providing a profile with settings for optimal playback on a cellular phone, the corresponding activity is to transfer the file to a cellular phone. After the file is saved, there is a pending operation to transfer the file to a cellular phone which needs to be performed.

If any operation needs to be performed after the content file is saved, the interface 406 allows the post-author component 404 to provide the plug-in component with a full path of the saved video and/or file. The path provided can either be a user specified location and/or a temporary location based on whether the video and/or file was explicitly saved by the user or implicitly saved by the post-author component.

If any operation needs to be performed after the content file is saved, the interface 406 can allow the post-author component 404 to provide to the plug-in component the full path of the saved content file, any additional files that contain information relevant to the authored content, and the profile that describes settings used when the content was saved. For example, if the user chooses to archive the authored content into a CD, after the content is saved to a file, an operation needs to be performed by the plug-in to copy the content file and all related files used in authoring the content to a CD. The plug-in would get this information from the post-author component 404 using the interface 406.

The interface 406 can also provide a function that allows the plug-in to launch user interface to perform any operation that needs to be performed after the content is saved. The post-author component 404 can call a function to launch such user interface, if any such operation is supported. In the example where the saved content needs to be archived to a CD, the function allows the third party plug-in to launch user interface to allow user to choose CD drive, drive speed, display CD writing progress, etc. It is to be appreciated that the user can choose to utilize an operation more than once (for example, to archive the content to more than one CD). In such case, the function to perform such operation can be called repeatedly for the third party plug-in component.

The interface 406 can also contain a function that can be called into the plug-in whenever the user chooses to find out more information about the plug-in. The third party plug-in component can be responsible to display details such as presenting a help file and/or a webpage. In one example, the additional information provides specific details on compatibility, authorization, and/or utility.

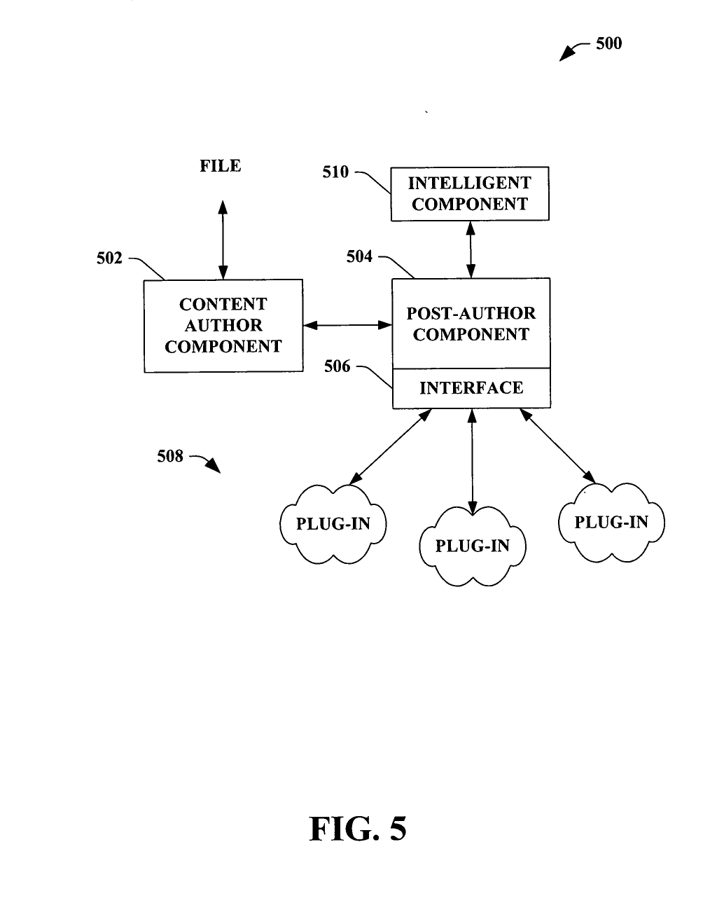

FIG. 5 illustrates a system 500 that employs intelligence to save a video and/or file. The system 500 includes a content author component 502, a post-author component 504, and an interface 506. As described in detail above, the content author component 502 can create a content and/or file. The post-author component 504 can save the content and/or file to a format respective to an output for presentation. The interface 506 can facilitate communication between at least one plug-in(s) 508. It is to be appreciated that the plug-in(s) 508 can be a third party plug-in as discussed above. The content author component 502, the post-author component 504, and the interface 506 can be substantially similar to the components depicted in previous figures.

The system 500 further includes an intelligent component 510. The intelligent component 510 can be utilized by the post-author component 504 to facilitate creating the content and/or file into the format with optimized settings. For example, the intelligent component 510 can be utilized to facilitate determining optimized settings in relation to a particular user. Historic data in conjunction with user profiles can allow the intelligent component 510 to determine optimal settings in relation to outputs typically utilized by the particular user. In another example, the intelligent component 510 can infer the format for which a user is to create the content and/or file.

It is to be understood that the intelligent component 510 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the subject invention.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

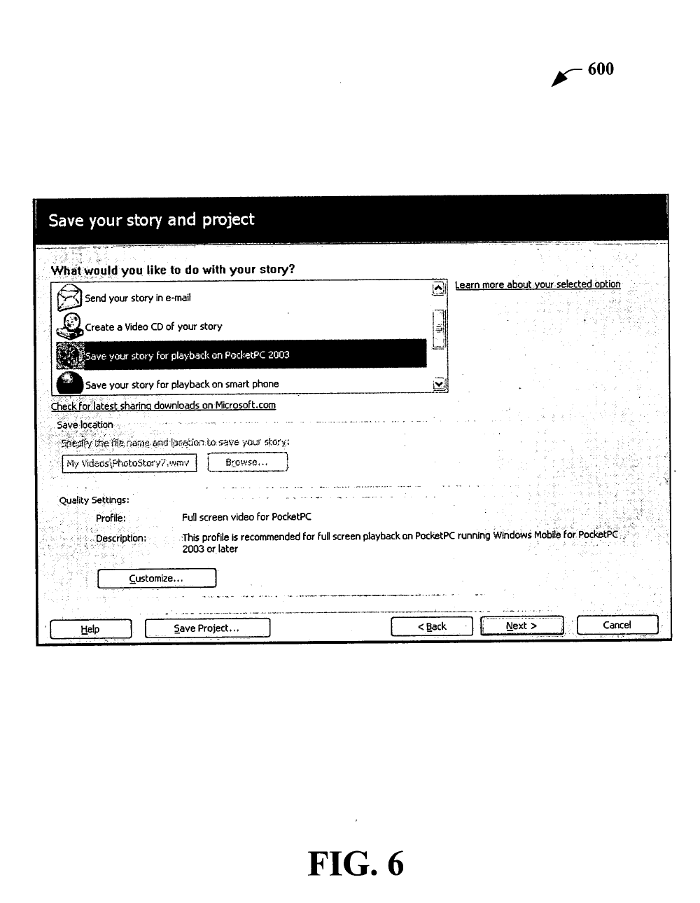

FIG. 6 illustrates a user interface 600 that facilitates creating a video and/or file in a particular format for a respective output. It is to be appreciated that the user interface 600 is one example and the subject invention can utilize any suitable interface. The user interface 600 can be a window-type application that includes a viewing area, wherein a user can select an operation to be performed on the video and/or file. As illustrated, the operations can be “Send your story in e-mail,” “Create a Video CD of your story,” “Save your story for playback on PocketPC 2003,” and “Save your story for playback on smart phone.” Although these operations are shown, it is to be understood that a plurality of operations can be employed by utilizing a scroll method as depicted. When the user selects a particular operation, the user interface 600 can display the optimal settings to the user and a description of the operation. Moreover, the user interface 600 can provide a “customize” feature that can allow the user to tweak and/or adjust various settings provided by the operation. Additionally, the user interface 600 can provide a help feature and a save project feature, which can assist the user and to save the progress of a project respectively.

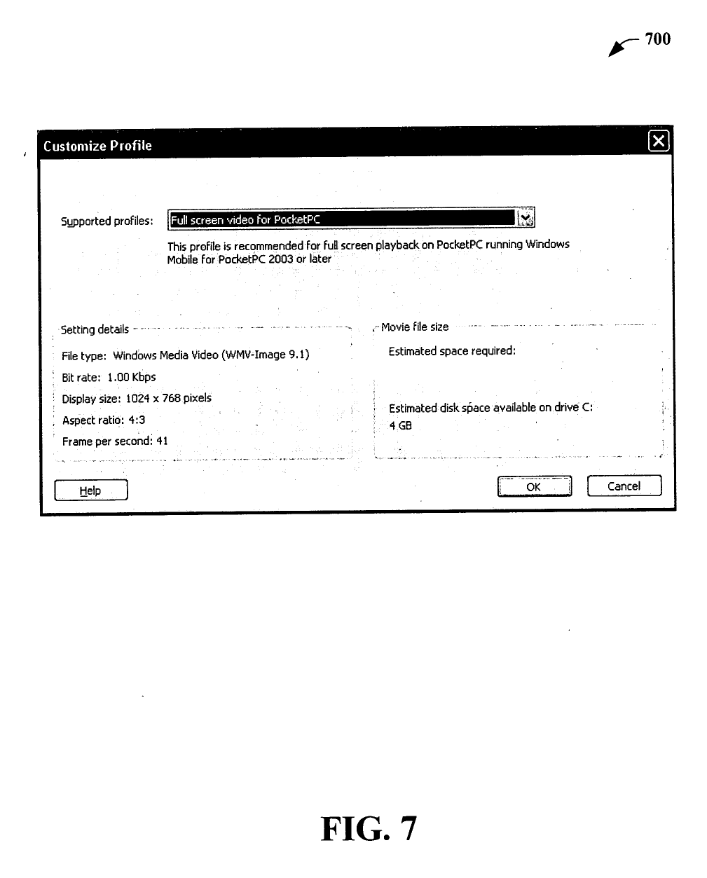

FIG. 7 illustrates a user interface 700 that facilitates creating a video and/or file for an output that has a respective format. In particular, the user interface 700 allows specific customization for a particular operation and/or format. For instance, the output and format illustrated is a “Full screen video for PocketPC,” in a pull-down and/or a pop-up menu including at least a subset of supported operations. The setting details can be adjusted by the user based at least upon a user preference. Accordingly, the settings can be applied when implementing the operation on the video. In another example, the user interface 700 can provide an estimation of video size, file size, the space available, and the space required to assist the user in managing drive space.

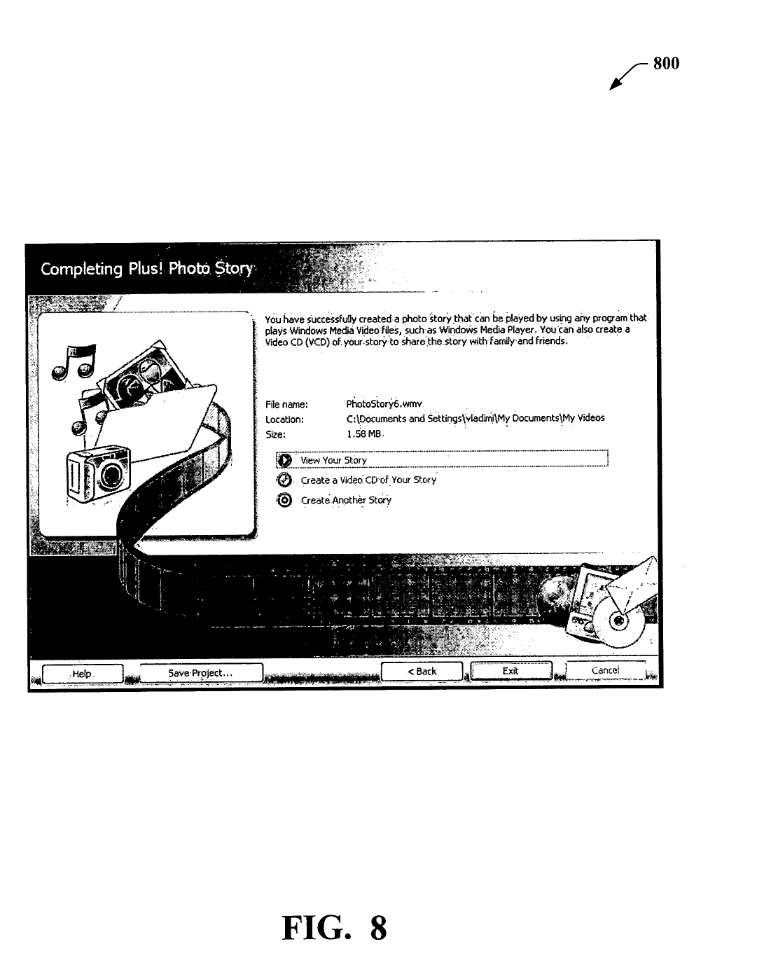

FIG. 8 illustrates how a post-author component can allow a plug-in to launch a user interface to perform any operation that needs to be performed after the content is saved. The post-author component can call a function to launch such user interface, if any such operation is supported. In the example of FIG. 8, a user interface 800 is shown where the saved content needs to be saved to a Video CD. The function allows the third party plug-in to launch the user interface to allow the user to choose a CD drive, drive speed, display CD writing progress, etc. It is to be appreciated that the user can choose to utilize an operation more than once by clicking on the “Create a Video CD” option shown in user interface 800.

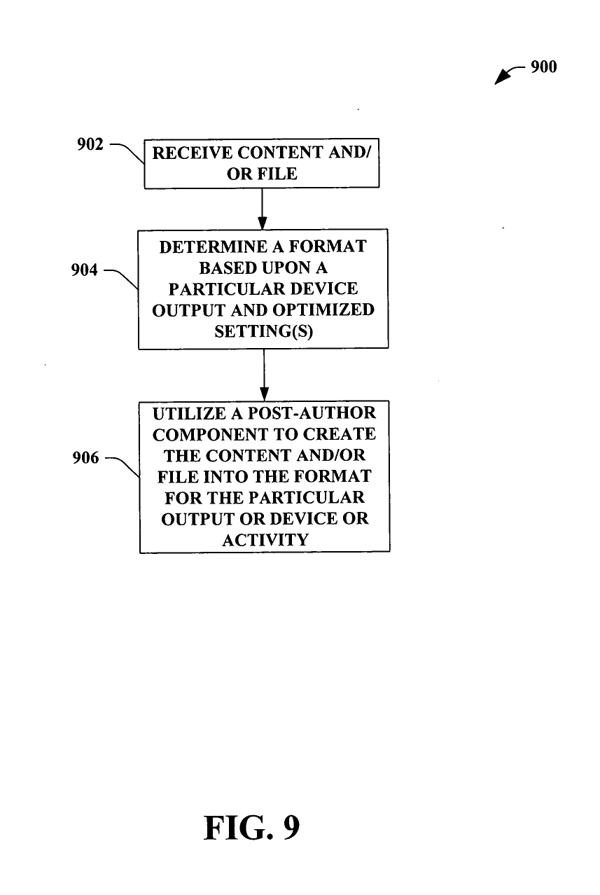

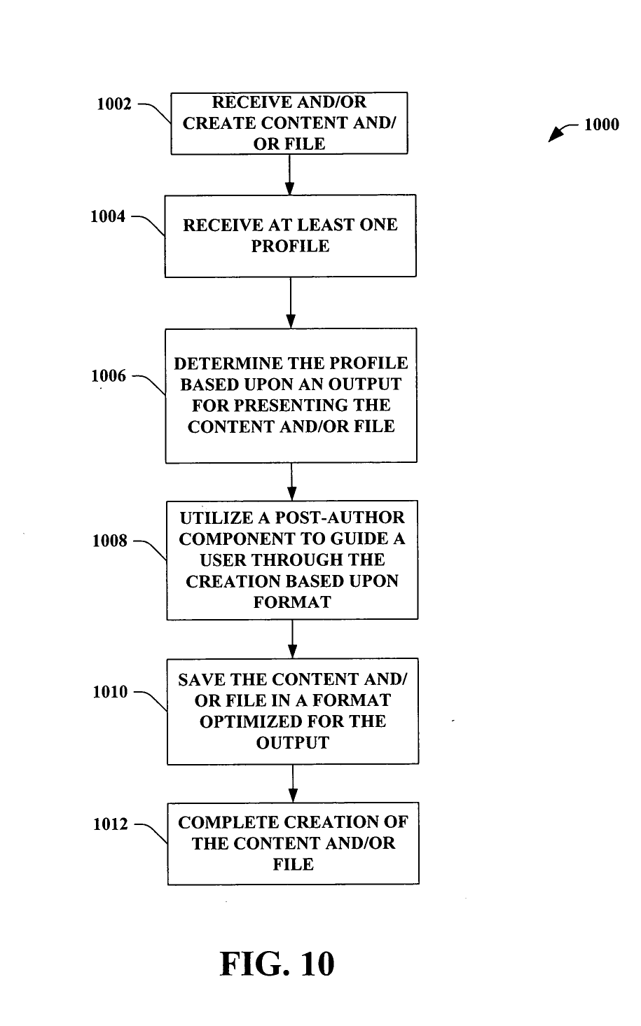

FIGS. 9-10 illustrate methodologies in accordance with the subject invention. For simplicity of explanation, the methodologies are depicted and described as a series of acts. It is to be understood and appreciated that the subject invention is not limited by the acts illustrated and/or by the order of acts, for example acts can occur in various orders and/or concurrently, and with other acts not presented and described herein. Furthermore, not all illustrated acts may be required to implement the methodologies in accordance with the subject invention. In addition, those skilled in the art will understand and appreciate that the methodologies could alternatively be represented as a series of interrelated states via a state diagram or events.

FIG. 9 illustrates a methodology 900 that facilitates creating content and/or file in a format respective to an output for presentation. At reference numeral 902, the content and/or file can be received. The content and/or file can be created and/or generated using an authoring component. At reference numeral 904, an output with an associated format can be determined and/or selected by a user. The output can be, but is not limited to, a television, a cellular phone, a projector, an email application, a website, a compact disc, a CD writing application, a digital video disc, a PDA, a pocket PC, . . . . The format can include settings, which can be optimized to provide the highest quality video. In other words, each output has a respective format with settings that vary to provide optimization in accordance to the output. In one particular example, the authoring application can be related to creating video, wherein the settings can be, but are not limited to, audio quality, video quality, video frame rate, video resolution, variable bit-rate, and constant bit-rate.

At reference numeral 906, a post-author component can be implemented to guide the user in saving the content and/or file in a format optimized for the particular output or device or activity. The post-author component can be software, an application, a user interface, and/or a graphic user interface. It is to be appreciated that the post-author component can be susceptible to a plug-in, wherein the plug-in can provide a particular format and associated output not previously available. For instance, following the video authoring application example, the plug-in can provide a post-authoring operation of writing the video and/or file to a CD. The post-author component can allow the selection of such operation, and save the content and/or file in a format optimized for the output and/or device and/or activity wherein the format is specified by the plug-in. When the content and/or file is saved in the optimized format, the post-author component can allow the plug-in to perform further operation, such as copying the content and/or file to a CD, to complete the activity. In other words, the plug-in capability of the post-author component provides an extensible, versatile environment for applications to seamlessly provide post-authoring operations to the video and/or file.

FIG. 10 illustrates a methodology 1000 that facilitates formatting a content and/or file in accordance with a particular output. At reference numeral 1002, the content and/or file is created and/or received. At reference numeral 1004, a profile can be received. The profile can be, for instance, a file set including optimized settings for a particular output for presentation. The profile can be custom-made, provided by a authoring component, provided by a plug-in component, and/or provided by a third party plug-in component. At reference numeral 1006, the profile to be utilized is determined based at least upon an output or device or activity for the content and/or file. A user can determine the output, from which the profile can be determined to provide the optimal settings for presenting the content and/or file.

At reference numeral 1008, the post-author component can allow the user to adjust and/or manipulate a setting within the profile to provide versatility in the output of the content and/or file. At reference numeral 1010, a post-author component can be employed to save the content and/or file in a format optimized for the output. The wizard can provide guidance utilizing various windows and/or functions to properly save the content and/or file with optimal settings. It is to be appreciated that the post-author component can utilize a plug-in component and/or a third party plug-in component to provide versatility and/or options for outputs and associated formats. Furthermore, the post-author component can utilize a third party plug-in component interface within itself to facilitate implementing the third party plug-in operation. Once the adjustments are complete, the content and/or file can be saved in the format associated to the output at reference numeral 1012. It is to be appreciated that the post-author component can utilize the plug-in component to perform any post-authoring activity that may need to be performed on the saved content and/or file.

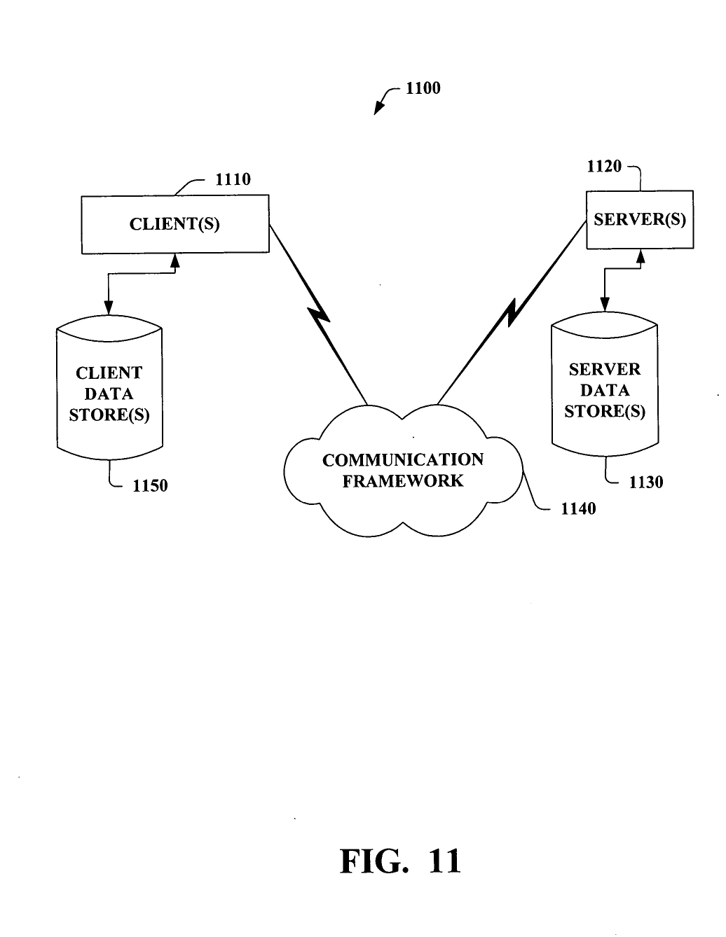

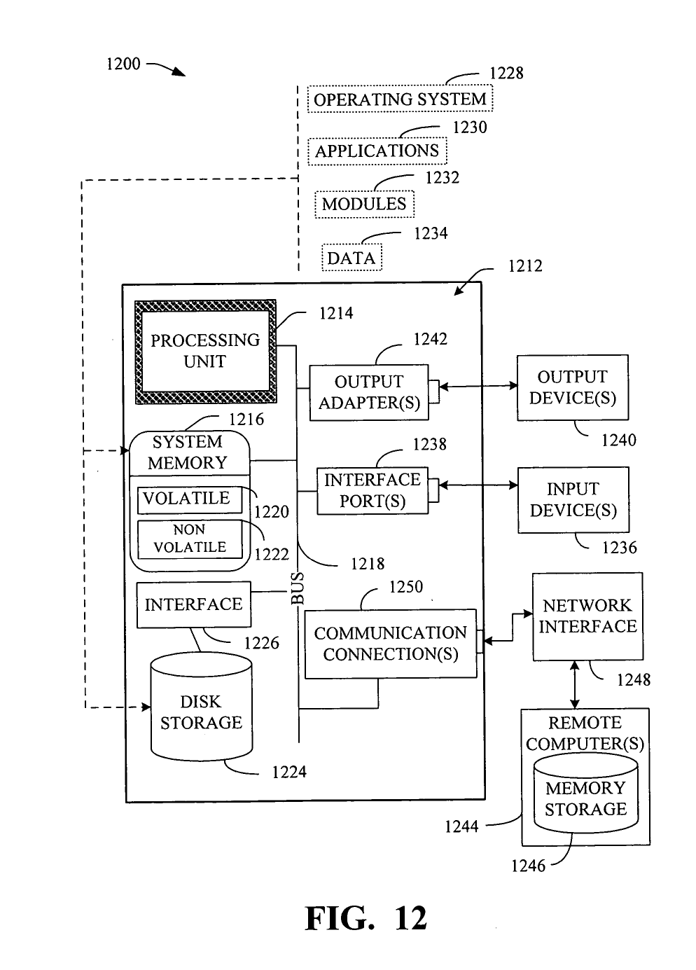

In order to provide additional context for implementing various aspects of the subject invention, FIGS. 11-12 and the following discussion is intended to provide a brief, general description of a suitable computing environment in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 11 is a schematic block diagram of a sample-computing environment 1100 with which the subject invention can interact. The system 1100 includes one or more client(s) 1110. The client(s) 1110 can be hardware and/or software (e.g., threads, processes, computing devices). The system 1100 also includes one or more server(s) 1120. The server(s) 1120 can be hardware and/or software (e.g., threads, processes, computing devices). The servers 1120 can house threads to perform transformations by employing the subject invention, for example.

One possible communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1150 that can be employed to store information local to the client(s) 1110. Similarly, the server(s) 1120 are operably connected to one or more server data store(s) 1130 that can be employed to store information local to the servers 1140.

With reference to FIG. 12, an exemplary environment 1200 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable programmable ROM (EEPROM), or flash memory. Volatile memory 1220 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in the suitable operating environment 1200. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the subject invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates saving authored content, comprising:
a content author component that allows authoring of a content; and
a post-author component that determines at least one of (1) an output device to render the content, and (2) a post authoring activity to perform with the content and to save the content in a format optimized for at least one of (a) displaying the content on the output device and (b) performing the post authoring activity.

2. The system of claim 1, wherein the user, after authoring content, chooses an output device to display the content or an activity to perform with the authored content and the system automatically determines at least one of (1) one or more formats for saving the content and (2) a preferred (default) format for saving the content such that the said formats are optimized for display of the content on the output device or for performing the activity.

3. The system of claim 1, further comprising a user interface specific to the post-authoring activity based at least in part upon a user and a choice of the post authoring activity to perform with the content.

4. The system of claim 1, the authored content is at least one of a video, a document, an image, a spreadsheet, a presentation, and content respective to an application that can be optimized for use in a specific activity.

5. The system of claim 1, the output device is at least one of the following: a television; a cellular phone; a projector; an email application; a website; a compact disc; a CD write application; a digital video disc; a PDA; a pocket PC; a compressed data; and a high definition display.

6. The system of claim 1, the post authoring activity involves at least one of the following: a transfer to a cellular device; an upload to a remote server; an upload to a website; a transfer to an email application; a transfer via email; a transfer to a compressed data; a display to a television; a display on a portable device; a transfer to a portable device; a transfer to a compact disc; a transfer to a CD via a CD application; a transfer to a DVD; and a transfer to a DVD via a DVD application.

7. The system of claim 1, the post-author component can utilize at least one plug-in such that each plug-in provides at least one of the following: (1) implementation for one or more activities that can be performed with the authored content, (2) specification of one or more formats optimized to at least one of display the authored content on an output device and perform the post-authoring activity, and (3) specification of a default or preferred format optimized to at least one of display the authored content on an output device and perform the post-authoring activity.

8. The system of claim 7, the plug-in component is a third party plug-in component.

9. The system of claim 7, the plug-in component provides a preferred format and a list of at least one supported format respective to at least one of the output device and the post authoring activity to be performed with the authored content.

10. The system of claim 7, the plug-in component provides implementation for a unique user interface to at least one of (1) display the content on an output device and (2) perform the post authoring activity.

11. The system of claim 1, the format is packaged as a profile described in an extensible markup language (XML) to provide the optimized format for at least one of displaying the content on an output device and performing the post authoring activity.

12. The system of claim 6, further comprising an interface that provides communication between the post-author component and a plug-in component.

13. The system of claim 12, the interface allows a plug-in component interface to be implemented within the post-author component to specify the format to save the content such that the format is optimized for at least one of the output device to display the content and the post authoring activity to perform with the content, wherein at least one of the output device, and the post authoring activity are associated to the plug in component.

14. A computer readable medium having stored thereon the components of the system of claim 1.

15. A computer-implemented method that facilitates saving content to one or more files, comprising:
receiving content;
determining an output device that renders the content;
determining a format of the content as a function of at least one of the output device to display the content and the post authoring activity to perform with the content; and
saving the content into a format optimized for at least one of the output device and the post authoring activity based on a user selection of the output device.

16. The method of claim 15, further comprising:
creating the content;
obtaining at least one profile;
determining the profile based at least upon one of the output device to display the content and the post authoring activity to perform with the content;
allowing an adjustment of at least one optimal setting; and
utilizing a plug-in component to provide at least one of (1) the profile and the format optimized for the at least one of the output device and the post authoring activity and (2) performing the post authoring activity after the content is saved in the optimized format.

17. The method of claim 15, further comprising implementing an interface to communicate to a plug-in component.

18. A data packet that communicates between a content author component and a post-author component, the data packet facilitates the method of claim 15.

19. A data packet that communicates between a plug-in component and a post-author component, the data packet facilitates the method of claim 15.

20. A computer-implemented system that facilitates creating a file, comprising:
means for receiving the content; and
means for determining an output device that renders the content; and
means for determining the format of the content as a function of at least one of the capabilities of the output device and the post authoring activity.
